(19) United States
(12) Patent Application Publication
(10) Pub. No.: US 2008/0262943 A1
(43) Pub. Date: Oct. 23, 2008

(54) AUCTION SYSTEM SUPPORTING ELASTIC AUCTIONS

(76) Inventor: Robert G. Mullendore, Missoula, MT (US)

Correspondence Address: PERKINS COIE LLP;PATENT-SEA, P.O. BOX 1247, SEATTLE, WA, 98111-1247, US

(21) Appl. No.: 12/111,163

(22) Filed: Apr. 28, 2008

Related U.S. Application Data
(63) Continuation-in-part of application No. 12/110,160, filed on Apr. 25, 2008.
Application No. 12/110,160 is a continuation-in-part of application No. 11/585,786, filed on Oct. 23, 2006.
(60) Provisional application No. 60/729,502, filed on Oct. 21, 2005.
(60) Provisional application No. 60/813,493, filed on Jun. 13, 2006.

(51) Int. Cl. G06Q 30/00

(52) U.S. Cl. 705/26

(57) ABSTRACT

A method and system for conducting auctions of multiple lots of items is provided. An auction system allows sponsors to set up auctions for the sale of one or more lots. The auction system allows considerable flexibility to a sponsor in defining how the auction should be conducted. An auction can be cyclical in that an auction for lots of a certain type is conducted on a cyclical basis so that sellers and buyers can prepare for the auctions. An auction can have the bidding on the lots of an auction terminate sequentially or terminate simultaneously. An auction can also be a direct auction or a reverse auction. An auction can be conducted completely online or have a combination of a live audience and a non-live audience.

### CROSS-REFERENCE TO RELATED APPLICATIONS

This application is a continuation-in-part of U.S. patent application Ser. No. 12/110,160, filed Apr. 25, 2008, entitled “AUCTION SYSTEM SUPPORTING AN ELASTIC BID MODE,” which is a continuation-in-part of U.S. patent application Ser. No. 11/585,786, filed Oct. 23, 2006, entitled “CYCLICAL AUCTION SYSTEM SUPPORTING VARIABLE TERMINATION,” which claims the benefit of U.S. Provisional Application No. 60/729,502, filed Oct. 21, 2005, and U.S. Provisional Patent Application No. 60/813,493, filed Jun. 13, 2006, which applications are incorporated herein by reference in their entireties.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. Although many of the commercial transactions that are performed today could be performed via electronic commerce, the acceptance and widespread use of electronic commerce depends, in large part, upon the ease of use of conducting such electronic commerce. If electronic commerce can be easily conducted, then even the novice computer user will choose to engage in electronic commerce. Therefore, it is important that techniques be developed to facilitate conducting electronic commerce.

The World Wide Web portion of the Internet is especially conducive to conducting electronic commerce. Many web servers have been developed through which vendors can advertise and sell products. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items.

The World Wide Web is also being used to conduct other types of commercial transactions. For example, some server computer systems have been developed to support the conducting of auctions electronically. To conduct an auction electronically, the seller of an item provides a definition of the auction via web pages to a server computer system. The definition includes a description of the item, an auction time period, and optionally a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

Auctions are currently conducted with live audiences in many different industries such as cattle and fine arts. Some of these auctions allow bidders to submit bids via telephone or via some other electronic means. For example, an auction may have a live audience and a telephone audience. The telephone audience may be participants in a conference call with the auctioneer. The members of the live audience can signal their bids visually or orally to the auctioneer. The members of the telephone audience can signal their bids orally by identifying themselves. Some of these auctions have very different formats and requirements from conventional online auctions. For example, certain cattle auctions may auction each lot of cattle at a very fast pace and may also move from lot to lot at a very fast pace. Current techniques for conducting auctions that have a live audience and a non-live audience (e.g., telephone audience) cannot support such a fast pace effectively.

### BRIEF DESCRIPTION OF THE DRAWINGS

FIG. 1 is an example display page that illustrates a listing of lots of an auction in the cattle industry.

FIG. 2 is an example display page that illustrates detailed information about a selected lot at an auction.

FIG. 3 is an example display page that illustrates a user interface displayed to a bidder in one embodiment.

FIG. 4 is example display page that illustrates detailed information about the current lot that is being auctioned.

FIG. 5 is an example display page of a user interface displayed during the active bidding phase.

FIG. 6 is a block diagram that illustrates components of the auction system in one embodiment.

FIG. 7 is a flow diagram that illustrates the processing of the ASP component of the auction system in one embodiment.

FIG. 8 is a flow diagram that illustrates the processing of the sponsor component of the auction system in one embodiment.

FIG. 9 is a flow diagram that illustrates the processing of the seller component of the auction system in one embodiment.

FIG. 10 is a flow chart that illustrates the processing of a one-button press component of the auction system in one embodiment.

FIG. 11 is a flow diagram that illustrates the processing of the one-button network bid component of the auction system in one embodiment.

FIG. 12 is a flow diagram that illustrates the processing an apply for auction sponsor component of the auction system in one embodiment.

FIG. 13 is a flow diagram that illustrates the processing of a set up auction component of the auction system in one embodiment.

FIG. 14 is a flow diagram illustrating the processing of an apply for seller component of the auction system in one embodiment.

FIG. 15 is a flow diagram that illustrates the processing of the upload lots component of the auction system in one embodiment.

FIG. 16 is a flow diagram that illustrates the processing of a preview and registration component of the auction system in one embodiment.

FIG. 17 is a flow diagram that illustrates the processing of an active bidding component of the auction system in one embodiment.

### DETAILED DESCRIPTION

A method and system for conducting auctions of multiple lots of items is provided. In one embodiment, an auction system allows sponsors to set up auctions for the sale of one or more lots. Each lot consists of one or more items that may be identical (e.g., art prints) or different (e.g., bulls). An auction is set up by its sponsor, who may be the seller of all lots or a third party serving as a broker for one or more sellers. The auction system allows considerable flexibility to a sponsor in defining how the auction should be conducted. For example, an auction can be cyclical in that an auction for lots of a certain type (i.e., commerce category) is conducted on a cyclical basis so that sellers and buyers can prepare for the auctions. An auction can have the bidding on the lots of an auction terminate sequentially or terminate simultaneously. An auction can also be a direct auction or a reverse auction. In addition, an auction can be conducted completely online or have a combination of a live audience and a non-live audience. The auction system provides these and other options for specifying how auctions are to be conducted. In addition, the auction system provides various mechanisms described below for conducting auctions with live and non-live audiences effectively while maintaining the enthusiasm of all audience members. The auction system allows an application service provider to make the auction system accessible to sponsors, sellers, and buyers of auctions. The application service provider can define commercial categories, which may be hierarchically organized, for various auctions. The sponsors of auctions can then use the auction system for the desired commerce categories. Sellers and buyers can then participate in the auctions in the desired commerce categories.

The auction system categorizes auctions according to control mode, bid mode, and termination mode. The control mode specifies whether an auction is an online, an external, or a hybrid auction. An external auction is controlled (e.g., the opening bid asked, the amount of each subsequent bid asked, and the decision to close bidding and either sell the article to the last bidder or withdraw the article from the sale) by a human auctioneer. An external auction may also allow bidders, referred to as Internet bidders, to submit bids via the Internet. The auction system may have a server component and a client component. Each Internet bidder interacts with the client component executing on their computer to submit bids. The client component forwards the bids to the server components, which then notifies the auctioneer of the bids. The auctioneer can accept bids from either the live audience or the Internet bidders. In addition, an external auction may have an agent present at the auction who may place bids on behalf of others, such as bidders who transmit standing bids electronically (e.g., via the Internet) to the agent.

An online auction is controlled by the auction system according to parameters set by the seller, sponsor, or application service provider prior to the sale. A hybrid auction is an auction that is controlled by the auction system but involves aspects of an external auction. In a hybrid auction, a live audience is present with and can view some of the lots being auctioned. An audience member may place a bid by signaling an agent who enters the bids and may act as an auctioneer in describing the lots and encouraging bidding activity. A hybrid auction may be considered to be a variation of an online auction with an audience entering bids through a single terminal or node.

The bid mode of an auction can be direct or reverse and non-elastic or elastic. Direct and reverse auctions are conventional in that they entail progressive bidding, in which bids are successive and each bid must be higher (or lower, in the case of a reverse auction) than the last and cannot be withdrawn. With the auction system, direct auctions are sponsored by sellers or third-party brokers, and potential buyers bid progressively higher prices. Reverse auctions are sponsored by buyers or third-party brokers, and potential sellers bid progressively lower prices. (In the following, the operation of the auction system is described primarily in terms of sellers and direct auctions, which operations can be adapted to apply to buyers and reverse auctions.) An elastic bid mode allows each bidder's bid for a lot to be entered, raised, lowered, or withdrawn by that bidder at any time before the bidding closes on the lot. When a non-elastic bid mode is used in a direct auction, each bidder can only enter and raise their bid. When an elastic bid mode is used in a direct auction, each bidder can also lower or withdraw their bid at any time. When a non-elastic bid mode is used in a reverse auction, each bidder can only enter and lower their bid. When an elastic bid mode is used in a reverse auction, each bidder can also raise and withdraw their bid at any time. An elastic bid mode provides a bidder with considerable flexibility in placing bids and may be considered to be very advantageous to the bidder.

The termination mode of an auction can be unstructured, simultaneous, or sequential. An auction can have multiple lots and each lot can have multiple items. Sellers auction off lots, and bidders place bids to purchase lots. For example, a rancher may want to auction off 500 head of cattle. The rancher may use the auction system to set up an auction with 5 lots with 100 head each or 4 lots with 100 head and 2 lots with 50 head. With unstructured termination, the bidding on each lot can terminate independently of the bidding on the other lots. For example, the bidding can be scheduled to terminate at different times or under different conditions. With simultaneous termination, the bidding for each lot is set to terminate at the same time. Because the bidding terminates at the same time, it would be impractical for an external auction to have multiple lots terminating simultaneously—as it would be difficult for human auctioneers to conduct and bidders to participate in auctions that terminate at the same time. Thus, the auction system may limit simultaneous termination to online or hybrid auctions. With sequential termination, the bidding on the lots is scheduled to terminate one after another. In such a case, the auction system allows a certain time between lots to allow bidders at a terminate lot time to bid on the next lot. The bidding for the lots may start at the same time or be staggered. For example, if a sequential auction has 5 lots with a specified sequence, then the bidding on the lots may start at the same time with the bidding terminating for one lot five minutes before termination of the next lot in the sequence. A sequential auction allows bidders to adjust their bidding patterns based on their success in the bidding on the previous lots.

In one embodiment, the auction system provides for cyclical auctions. (Non-cyclical auctions are referred to as ad hoc auctions.) A cyclical auction has a commerce category and an established cycle of recurring times for auctioning lots of items in that commerce category. For example, a cyclical auction may be set up for hogs to take place every Friday at noon, and another cyclical auction may be set up for calves to take place every other Tuesday at 10 AM. An application service provider (“ASP”) who operates the auction system may set up cyclical auctions for various commerce categories and advertise those auctions. For example, one ASP that provides an auction system for the cattle industry may provide a comprehensive set of commerce categories for the cattle industry (e.g., semen and calves). The ASP may define a cyclical auction for each commerce category with a cycle that is tailored to the commerce category. The ASP can then publicize the cyclical auctions to the appropriate area of commerce. Sellers and buyers in that area of commerce (e.g., cattle or antique automobiles) can then plan to participate in the appropriate auctions at the recurring scheduled times. Various sellers can then add lots to the auction that meet the criteria of the auction. The seller may be an organization that has been consigned items to sell.

In one embodiment, the auction system allows lots of a cyclical auction that go unsold in one cycle to be automatically added to a subsequent cycle, such as the next cycle, for that cyclical auction. The automatic adding of unsold lots to a subsequent cycle is referred to as automatic renewal. The auction system does not change the lot parameters for an automatically renewed lot. The auction system allows additional lots to be added in between cycles for sale at the next auction cycle and automatically renewed lots to be removed in between cycles. Thus, a cyclical auction may be in progress continually and restocked with lots as necessary.

The auction system divides an auction that has been set up into phases. These phases are preview and registration, advance bidding, active bidding, termination, subsequent choices, and payment and delivery. In the preview and registration phase, the auction system allows buyers to register and view information describing the auctions. A buyer who is interested in placing bids at an auction registers for that auction. In the advance bidding phase, the auction system allows buyers to register, if not already registered, and to place standing bids or pre-emptive bids, assuming that they are allowed by the auction. When a standing bid is placed, the auction system automatically places bids on the buyer's behalf up to the maximum amount indicated by the standing bid. A pre-emptive bid is for an amount for which the seller is willing to immediately sell the lot. Whenever a buyer submits a pre-emptive bid for a lot, the auction system removes that lot from the auction so that it can be sold to the buyer for the pre-emptive bid amount. In the active bidding phase, the auction system allows buyers to register, if not already registered, and to view and actively bid on lots. Buyers may also submit standing bids and pre-emptive bids, assuming they are allowed by the auction. When a buyer places a bid, the buyer may jump the asking price on any lot by manually entering a higher bid amount or by selecting an appropriate bid amount from a displayed list of bid amounts. In the termination phase, the auction system terminates lots according to the termination sequence specified when a sequential termination auction is set up. The termination phase allows for overtime bidding if specified when the auction was set up. In the subsequent choice phase, the auction system allows a seller to accept or reject a high bid that is below a specified minimum bid. In a conventional auction, the bidder bids only a bid amount. At the termination, the winning bidder is allowed to accept any quantity being auctioned at the bid amount. If any quantity is left, the bidder with the second highest bid selects quantity at their bid amount, and so on. This type of conventional auction gives the bidders flexibility in quantities to accept depending on their bid amount. The sponsor of the auction is obligated to accept the decisions of the bidders. Also, one or more buyers may select one or more items of the lot if the auction specifies multi-item or fractionated lots (described below). A seller alternatively may elect to place any unsold items back into inventory or to select another selling method. In the payment and delivery phase, the auction system helps sellers and buyers track and record the payment and delivery. Each party may use the auction system to record “fact” relating to the consummation of the sale. The facts may include whether payment was sent or received, whether items were shipped or received, and so on. The auction system may identify and report discrepancies such as the buyer recording payment sent but the seller recording payment not received.

Overtime time bidding occurs based on bids placed during a safe harbor period that is during the end of the active bidding phase. If no bid is submitted prior to the safe harbor period but two or more bids are submitted during the safe harbor period, then the bidding continues into overtime. If at least one bid is submitted prior to the safe harbor period and at least one bid is submitted during the safe harbor period, then the bidding continues into overtime. The end of each overtime period may also have a safe harbor period to further extend the bidding into another overtime period. An auction may be set up to allow overtime bidding for all prior bidders on a specified lot or only for those bidders who bid during the safe harbor period (except for the last bidder before the safe harbor period when only one bidder bids during the safe harbor period). The auction system may automatically apply a safe harbor period (e.g., 60 seconds) to any auction with simultaneous or unstructured termination except when the bidding on a lot terminates before the normal bidding time expires (e.g., because of a pre-emptive bid).

The auction system may allow hybrid auctions to be single-site or multi-site. In a single-site auction, the auction system broadcasts live audio and video from a single auction location, where a live audience is present. In a multi-site auction, the auction system broadcasts live audio and video from multiple auction locations where live audiences are present. The broadcast may rotate to the various locations. Alternatively, the auction system may broadcast each auction simultaneously so that each auction can display the video from each other auction. The auction system may also allow control of the auction to rotate to agents at each location. The agent with control may be responsible for describing the lots and entering the bids, received locally or from another auction site, into the auction system.

The following table provides descriptions of various categories of auctions.

| Name | Description |
|---|---|
| Ad hoc, unstructured | an online auction without a live audience, |
| termination | that is not cyclical, and where lots terminate |
| | individually as sold |
| Ad hoc, simultaneous | an online auction without a live audience, |
| termination | that is not cyclical, and where the active |
| | bidding phase of each lot ends at the same time |
| Ad hoc, sequential | an online auction without a live audience, |
| termination | that is not cyclical, and where the active |
| | bidding phase of each lot ends sequentially |
| | at established times |
| Cyclical, simultaneous | an online auction without a live audience, |
| termination | that is cyclical with automatic renewal and |
| | with adding of lots between cycles, and where |
| | the active bidding phase of each lot ends at |
| | the same time |
| Cyclical, sequential | an online auction without a live audience, |
| termination | that is cyclical with automatic renewal and |
| | with adding of lots between cycles, and where |
| | the active bidding phase of each lot ends |
| | sequentially at established times |
| Hybrid, ad hoc, | an online auction with a live audience at one |
| single site | location, that is not cyclical, and where the |
| | active bidding phase of each lot ends |
| | sequentially at established times |
| Hybrid, cyclical, | an online auction with a live audience at one |
| single site | location, that is cyclical with automatic |
| | renewal and with adding of lots between cycles, |
| | and where the active bidding phase of each lot |
| | ends sequentially at established times |
| Hybrid, ad hoc, | an online auction with a live audience at |
| multi-site | multiple locations, that is not cyclical, |
| | and where the active bidding phase of each |
| | lot ends sequentially at established times |
| Hybrid, cyclical, | an online auction with a live audience at |
| multi-site | multiple locations, that is cyclical with |
| | automatic renewal and with adding of lots |
| | between cycles, and where the active bidding |
| | phase of each lot ends sequentially at |
| | established times |
| External, single site, | a live auction at one location where the |
| sequential termination | auctioneer controls the auction, where bids |
| | may be submitted online, and where the active |
| | bidding phase of each lot ends sequentially |
| External, reverse node | a live auction at one location where the |
| | auctioneer controls the auction, where bids |
| | may be submitted online and an agent visually |
| | relays standing bids and changes to standing |
| | bids submitted by the Internet audience to the |
| | auctioneer, and where the active bidding |
| | phase of each lot ends sequentially |

The auction system may allow agents to perform various functions on behalf of others. A function of an agent may be to relay bids submitted by others. At an online auction, an agent relays bids by receiving bids from a live or telephone audience and entering the bids at the online auction using a computer of the auction system (referred to as a node). At an external auction, an agent can relay bids, typically standing bids, received from bidders who submit bids via a computer. The agent views the bids at the auction site using a computer of the auction system (referred to as a reverse node) and conveys those bids visually or orally to the auctioneer.

The auction system allows a bidder who wants to purchase a bidder-specified maximum number of lots to place standing bids for any number of lots up to the number of lots in the auction. The bidder assigns a priority order to lots with the standing bids and the specified maximum number of lots to purchase. For example, if an auction has 10 lots designated as lots A-J, a bidder may want to purchase at most 4 lots. In such a case, the bidder may request to place standing bids on 6 lots, A, B, C, D, G, and J. The bidder may assign a priority order to the lots of D, G, B, A, J, and C, meaning that the bidder would rather purchase lots D, G, B, and A, but purchasing lots J and C would be acceptable. The auction system ensures that the bidder has placed the current highest bid in no more than the specified maximum number of lots to purchase. The auction system places standing bids for those lots in priority order. A standing bid remains in effect until the bidder wins the lot or the standing bid is superseded by another bid. If a standing bid is superseded, then the auction system places another standing bid for a different lot on behalf of the bidder in priority order. After the termination of all lots (either simultaneously or sequentially), the bidder will have won no more than the maximum number of lots. Continuing with the example, in an auction with simultaneous termination, the auction system places standing bids for lots D, G, B, and A, initially. If the standing bid for lot G is superseded by another bidder's bid, the auction system places a standing bid for lot J (assuming the current highest bid for lot J is not already higher than the standing bid). At the termination of the auction, the bidder may have won no lots or any combination of four or fewer lots A, B, C, D, G, and J.

An external auction uses an auctioneer who interacts with the audience by describing the lots for sale, calling out the current bid, deciding on the asking price for the next bid, and calling out for and accepting bids at higher and higher levels. The auctioneer also closes the bidding when no higher bids are forthcoming. The auctioneer is in control of the auction and keeps the auction moving.

The auction system may extend the environment of being present at an external auction to Internet bidders who are not present at the auction location. The auction system provides a client component, referred to as an active bidding monitor, that extends the environment by letting the Internet bidders both see and hear bidding activity. The client component automatically updates the current bid and the asking bid as lots are viewed, uses sound effects to indicate changes in bid level and whether the viewer is in the lead, and uses graphics to show the number of bids received at each bid level. Since the bidding at a live auction may occur rapidly with bids increasing by differing increments depending on the auctioneer's assessment of bidding activity, it may be difficult for the auction system to display the current bid and the asking bid in real time to the Internet bidders. Nevertheless, as described below, the auction system can notify Internet bidders in real time (e.g., audibly or visually) when a bid is accepted and a new asking bid is established and when the Internet bidder's own bid was accepted. The auctioneer may, in addition to describing the lots and soliciting bids, comment about the relative numbers of bids coming from the live and Internet audiences. The client component may include graphics to depict the current phase and the time remaining.

The auction system may provide an auctioneer with one button or two buttons to signal the auction system that a bid has been accepted so that the auction system can then notify the Internet bidders. The buttons are typically placed in view of the live audience. When the auction system provides one button, it has a light and the auctioneer pushes the button to accept a bid. The light on the button indicates whether a bid has been received from an Internet bidder at the current asking bid. Whenever the auction system receives a bid at the current asking bid from an Internet bidder, the auction system will light the button. If the button is unlighted when pushed by the auctioneer, then the auctioneer has accepted a bid from the live audience. If the button is lighted when pushed by the auctioneer, then the auctioneer has accepted a bid from an Internet bidder. The auction system unlights the button whenever it is pushed (if lighted), and the process restarts at the new current asking bid. When a bid is accepted from an Internet bidder, the auction system sends an “acceptance” sound to the bidder whose bid was accepted (i.e., the first bidder at the previous current asking bid) and sends a “new asking bid” sound to all the other Internet bidders. The sounds will inform the Internet bidders whether their bid was accepted and will warn them to listen to the audio of the auction for the new asking bid. Once the button is lighted, the auctioneer cannot accept the bid from the live audience by pressing the button as it will signal to accept the bid from the Internet audience.

The auction system provides two buttons to give an auctioneer the ability to accept a bid from the live audience even though a bid from an Internet bidder has been received. The auction system provides one button with a light, referred to as the Internet audience button, and another button without a light, referred to as the live audience button. The auctioneer pushes the live audience button to signal acceptance of a bid from the live audience and pushes the Internet audience button to signal acceptance of a bid from the Internet audience. The auction system lights up the Internet audience button whenever a bid is received from an Internet bidder at the current asking bid. When the Internet button is lighted, the auctioneer has the option of not accepting the Internet bid. The live audience will be able to see the light and know that a bid from the Internet audience has been received. The auctioneer may not immediately accept the Internet bid in hopes of stimulating bidding activity within the live audience. If only audio is transmitted to the Internet bidders, they may not know that a bid has been placed (except possibly for the Internet bidder who placed the bid). The auction system could, however, play an auxiliary sound to the live audience so that the Internet audience will know that an Internet bid has been placed. Whenever the auctioneer accepts a bid as signaled by pushing a button, the auction system unlights the Internet audience button (if lighted) and sends an acceptance sound or a new asking bid sound to the Internet bidders as described above. The auction system could alternatively send two different new asking bid sounds to the Internet audience to distinguish whether the new asking bid is a result of a bid placed by the live audience or by the Internet audience.

In the time delay between when an Internet bidder places a bid at the current asking bid and when the auction system receives notification of the bid, the auctioneer may have accepted another bid at the current asking bid (e.g., from the live audience or another Internet bidder). The auction system may be implemented using a client/server model, where an auction server communicates with the auction clients of the Internet bidders. Since the Internet bidder's computer will not be provided with the asking bids, the bid sent by an Internet bidder will only indicate a desire to place a bid at what the bidder believes is the current asking bid, but will not include that asking bid, which the Internet bidder may only know of by listening to the audio of the auction. The auction system uses “bookmarks” to track whether an Internet bid is for the current asking bid or for a previous asking bid. A bookmark includes a time indicating the time when the asking bid changed. Whenever a bid is accepted as indicated by the auctioneer pressing the button, the auction server establishes a new bookmark to indicate the time of the new asking bid. The auction server also sends the bookmark to the computer of each Internet bidder. Whenever an Internet bidder places a bid, the bidders auction client sends to the auction server a notification of the bid that includes the last received bookmark. When the auction server receives the notification of the bid, it compares the received bookmark to the current bookmark. If they are the same, then the Internet bid is for the current asking bid and the auction server lights up the button to indicate that an Internet bid has been received. If they are not the same, then the Internet bid is for an out-of-date asking bid and the auction server discards the bid.

The auction system may allow an auction to specify that the items in a lot may be sold to different bidders, referred to as a fractionated lot. Normally, all items in a lot are sold to the winning bidder. The way in which the items of a fractionated lot are sold may depend on whether the items in the lot are identical. For example, if the items are identical (e.g., limited edition art prints), the seller may wish to auction off a certain number of items to the highest bidder(s) and then sell the remaining items for a fixed price. As another example, if the items of the lot are not identical (e.g., bulls), then after the bidding terminates bidders are allowed to select the items of the lot they want to purchase with the highest bidder selecting first and proceeding in bid order until all the items are purchased or the bids are exhausted. Each bidder may be allowed to select one or more items depending on how the auction is set up. The purchase price for each bidder may be their actual bid amount, the bid amount of the lowest winning bidder, an average amount of the winning bids, and so on.

The auction system may use listing templates to allow sponsors to provide information on their lots that will be available to bidders. An ASP may set up an auction with templates that define the minimum information that a sponsor needs to provide with adding a lot to the auction. This minimum information may be used to help ensure that lots will meet the minimum criteria of the auction (e.g., cattle under two years old). The auction system may allow a sponsor to provide supplemental information that may be restricted to certain viewers (e.g., the ASP or viewers who pay a premium). During an auction a lot is described or specified by the information appearing in the listing template and the supplemental information. The templates may be used for entity tracking without any association with an auction. For example, a potential seller may create inventories of pre-sale lots that each consist of one listing with supplemental information for individual animals or groups of animals before deciding how and when to sell them. Thus, the auction system allows sellers to define tentative sale groups. For example, a rancher may create a group as early as calving season, although no calves will be auctioned until weaning and although some may be retained for months or even years thereafter. Over time, the listings and supplemental information of these pre-sale lots may be revised with new information or with changed plans. Pre-sale lots may be used for entity tracking and source verification apart from, or in preparation for, commercial transactions, such as an auction.

In addition to elastic and non-elastic bid modes, an auction can also have a sponsor selection mode that is elastic or non-elastic. The sponsor selection mode refers to the rules that govern how the winning bids of an auction are accepted when the auction closes. Since the bids pending at the close of an auction are considered binding on the bidders, the sponsor selection mode also binds the sponsor in various ways. An auction with a sponsor selection mode of non-elastic is a conventional sponsor selection mode in which the sponsor at the close of the auction is obligated to accept the winning bids. An auction conducted using an elastic bid mode and a non-elastic sponsor selection mode may be considered to be favorable to the bidder because of the bidding flexibility and the sponsor selection inflexibility. An auction conducted, however, with both an elastic bid mode and an elastic sponsor selection mode can help offset such favorableness to the bidder.

Sponsor selection modes can specify a combination of sponsor selection options. The sponsor selection options includes whether the sponsor is required to accept the auction quantity (established when the auction was created), whether the sponsor can reject initial winning bids and accept initial non-winning bids, and whether the sponsor can accept in excess of the auction quantity. The initial winning bids are those bids pending at the close of the auction with the most favorable prices to the sponsor that aggregate to auction quantity. (A sponsor may decide to reject a bid for a more favorable price who the sponsor considers the bidder to be less than reputable.) Different choices for the first two sponsor selection options result in four possible types of sponsor selection modes as outlined in the following table. The four types of sponsor selection modes illustrated by the table each have the requirement that the sponsor cannot accept bids whose aggregate exceeds the auction quantity. The auction quantity can thus be considered to be a maximum quantity that the sponsor can accept (see below where this requirement is removed).

| Type | Quantity Required | Accept Initial Non-Winning Bids |
|---|---|---|
| I | Yes | No |
| II | Yes | Yes |
| III | No | No |
| IV | No | Yes |

A type I sponsor selection mode corresponds to a non-elastic sponsor selection mode in which the sponsor is obligated to accept the initial winning bids. The differences in the sponsor selection modes are illustrated in the context of an example auction for a fractionated lot of 2,000 head of cattle when six bids for 500 head each are pending at the close of the auction. The two least favorable bids are the initial non-winning bids. With a type I sponsor selection mode, the sponsor at the close of the example auction is obligated to accept the four highest bids.

A type II sponsor selection mode is an elastic sponsor selection mode that obligates the sponsor to accept bids that aggregate to the auction quantity, but allows the sponsor to accept initial non-winning bids at the sponsor's discretion. Continuing with the example auction, with a type II sponsor selection mode, the sponsor may reject one of the initial winning bids, but is then obligated to accept one of the two initial non-winning bids. The sponsor could not reject three of the initial winning bids because that would result in an acceptance of less than the auction quantity as there are only two initial non-winning bids that can be accepted.

A type III sponsor selection mode is an elastic sponsor selection mode that does not obligate the sponsor to accept bids that aggregate to the auction quantity, but prohibits the sponsor from accepting an initial non-winning bid. Continuing with the example auction, with a type III sponsor selection mode, the sponsor can reject any of the four initial winning bids, but cannot accept any of the two initial non-winning bids. Thus, the sponsor can accept bids that total 0, 500, 1000, 1500, or 2000 head from the four initial winning bids.

A type IV sponsor selection mode is an elastic sponsor selection mode that does not obligate the sponsor to accept bids that aggregate to the auction quantity and allows the sponsor to accept an initial non-winning bid at the sponsor's discretion. Continuing with the example auction, the sponsor can accept any four of the six bids.

A type V auction is an elastic sponsor selection mode in which the auction sponsor can accept any bids including bids that total more than the auction quantity. Continuing with the auction example, the sponsor can reject the most favorable initial winning bid and accept the remaining five bids for a total quantity of 2500 head. For a type V auction, the auction quantity, if specified, can be considered to be advisory in the sense that it may provide a bidder with an indication of the general quantity that the sponsor will accept, although not obligated to do so.

The auction system allows elastic auctions that use the elastic bid mode and/or an elastic sponsor selection mode to be set up as either direct or reverse auctions. An elastic auction can be used to sell an entire lot of the auction to a single bidder in a direct auction or to buy an entire lot from a single bidder in a reverse auction. An elastic auction can also be used to sell items of a fractionated lot to different bidders in a direct auction or to buy items of a fractionated lot from different bidders in a reverse auction. An elastic reverse auction may be used to buy a lot of any commodity (e.g., feed cattle or processed beef). A sponsor, such as a packing plant, who wants to purchase cattle, may set up an elastic reverse auction with an elastic bid mode and a type II sponsor selection mode. The packing plant may want to purchase 10,000 head per week (e.g., 2,000 head per weekday). The elastic reverse auction may include 5 fractionated lots of 2,000 head each to be delivered on successive days of a week. For each fractionated lot, a bidder, such as a feedlot, may submit a bid that specifies a bid amount and a fractional quantity of the 2,000 head of the fractionated lot (e.g., 100 head out of the 2,000). During the course of the elastic reverse auction, many feedlots may submit bids for different fractions of the fractionated lot at different bid amounts. Each feedlot may, at any time before the close of the auction, withdraw their bid, increase or decrease the fraction of their bid, or raise or lower the bid amount of their bid. A feedlot may even submit multiple bids for different fractions and different bid amounts. If each bidder can see the other bids, each bidder knows whether their bid is low enough to win. At the close of this elastic reverse auction, the total quantities of the bids for a fractionated lot may be more than, equal to, or less than the 2,000 head of the fractionated lot. Since this elastic reverse auction uses a type II sponsor selection mode, the packing plant is obligated to accept bid that aggregate to 2000 head (assuming enough bids), but can reject an initial winning bid and accept an initial non-winding bid at the packing plant's discretion (again assuming enough bids).

An elastic direct auction that specifies an elastic bid mode and/or an elastic sponsor selection mode may be used to sell a lot of any commodity (e.g., bushels of corn). A sponsor, such as a farmer, who wants to sell corn not yet harvested, may set up an elastic direct auction with a fractionated lot with an elastic bid mode and a type III sponsor selection mode. The type III sponsor selection mode may provide assurances to the highest bidders that they will not be skipped over at the farmer's discretion. The quantity of corn that is available may vary based on weather conditions, disruptions in raw materials (e.g., fertilizers), insects infestations, and so on. Because the farmer does not know the actual quantity that will be available, the farmer may set the quantity of the fractionated lot of the elastic direct auction to be an estimated maximum production of 10,000 bushels. A feedlot, who needs corn, may submit a bid that specifies a fraction of the fractionated lot and a bid amount. Many different feedlots can submit bids that specify a fraction and a bid amount. The feedlots thus bid to be higher in the priority list for whatever quantity the farmer does eventually harvest. Because the auctions has an elastic bid mode, each feedlot may, at any time before the closing of the auction, withdraw their bid, increase or decrease the fraction of their bid, or raise or lower the bid amount of their bid. Since each bidder can see the other bids, each bidder knows where their bid stands in relation to the other bids. (In some embodiments, the auction system may allow the sponsor of any auction to specify what bidder information is available to the other bidders. For example, the auction system may displaying ranking information to other bidders but not bid amounts.) At the close of the auction, the highest priced bids up to the total quantity of the fractionated lot are considered the winning bids. If the actual harvest is less than the quantity of the fractionated lot, the farmer delivers the corn to the feedlots in bid amount priority order.

The auction system supports auction with any combination of bid mode and sponsor selection mode. A sponsor will typically select a combination to maximize the chances of the sponsor achieving its objective. The sponsor needs to take into consideration likely bidder reaction to the sponsor selection mode of the auction. Even though a sponsor may want the flexibility to accept less than the auction quantity (i.e., sponsor selection mode types III, IV, and V), some bidders may not want to participate if they know their initial winning bid can be rejected simply because the sponsor decides to accept a lesser quantity. The sponsor may also want to factor in whether the items being auctioned are fungible or unique in selecting a sponsor selection mode. For example, if a feedlot is buying 1000 calves, which are each unique, the feedlot may select a sponsor selection mode of type IV so that the feedlot can select any of the bids and not just the initial winning bids and is not obligated to accept even any of the bids. If a farmer is selling 1000 bushels of corn, which are fungible, the farmer may select a sponsor selection mode of type I or III depending on whether the corn has already been harvested. When a sponsor is selling unique items, the sponsor may allow the winning bidders to select the unique item in order of their bid amount. For example, in a direct auction of 100 bulls, the highest bidder gets their choice of bulls up to their bid fraction, the second highest bidder the get their choice of the remaining bulls up to their bid fraction, and so on. The sponsor may select a selection mode of type II for such an auction because the sponsor may want some flexibility to reject bids of bidders with a poor reputation.

The auction system allows a sponsor or consignor to specify different user interface layouts so that the appropriate information regarding a particular lot can be displayed to bidders prior to and during an auction. The sponsor-defined user interface is particularly important in an auction with sequential termination. With such an auction, a bidder needs sufficient information to make a decision whether to place a bid based on the previous bid at the auction and the lots yet to be auctioned. The auction system defines sectors that each display different types of information about the auction. A sponsor or consignor can supply specified information to the multiple sectors that are visible to bidders and that are coordinated with the selected lot. Different sector layouts may be chosen by the auction sponsor as desired and may include some combination of an active bid monitor sector; a video sector for slide shows; prerecorded video, and/or live video; one or more advertising sectors; a listing sector with background information; and a supplemental information sector for display of additional data not included in the listing.

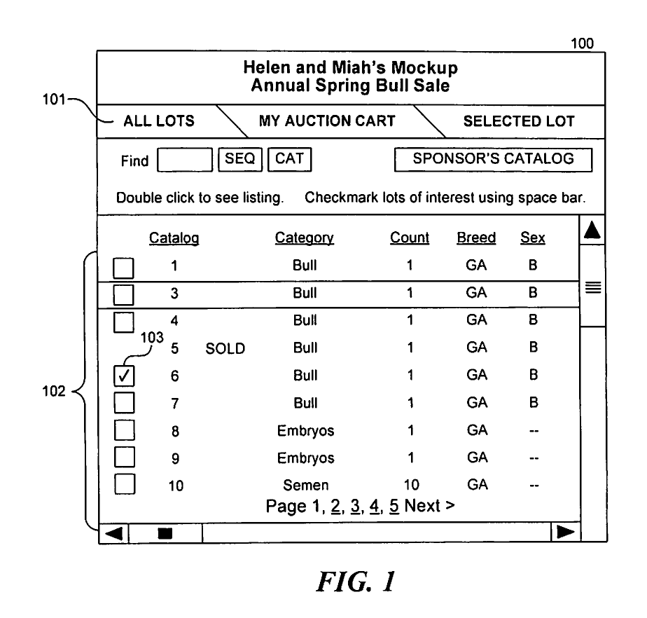

FIG. 1 is an example display page that illustrates a listing of lots of an auction in the cattle industry. Display page 100 contains various tabs such as the all lots tab 101 and contains a listing area 102 that lists the lots of various auctions of the sponsor. The auctions include lots in different commercial categories of the cattle industry such as bulls, embryos, and semen. A user can select a lot to view more detailed information about the items within the lot. The auction system also allows the user to record interest in a lot as indicated by a check mark 103. The auction system allows the user to search for and view lots that have been marked of interest.

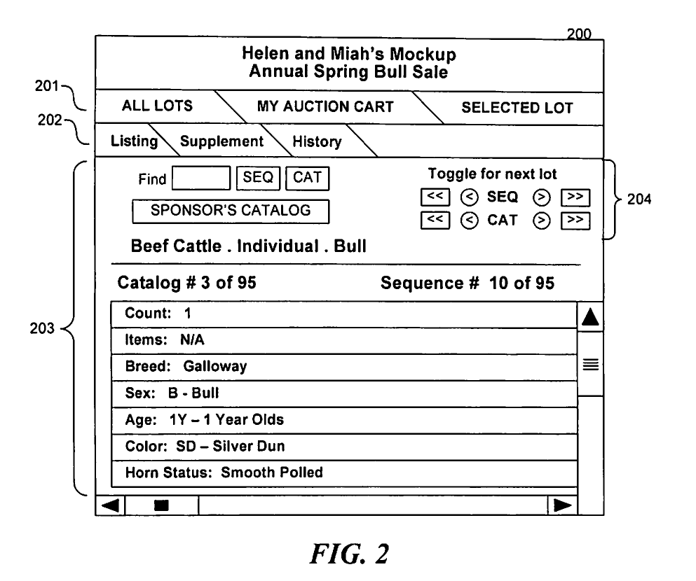

FIG. 2 is an example display page that illustrates detailed information about a selected lot at an auction. Display page 200 contains various tabs 201 and sub-tabs 202. In this example, the all lots tab and the listing sub-tab are selected. The display page contains a listing area 203 that contains detailed information relating to the selected lot. The display page includes additional sub-tabs such as a supplement and a history sub-tab that provide more detailed information about the items in the lot. The display page includes a sequence and catalog button area that allows the user to select the next sequence number or catalog number for the sponsor. The sequence number corresponds to the order in which the lots will be auctioned.

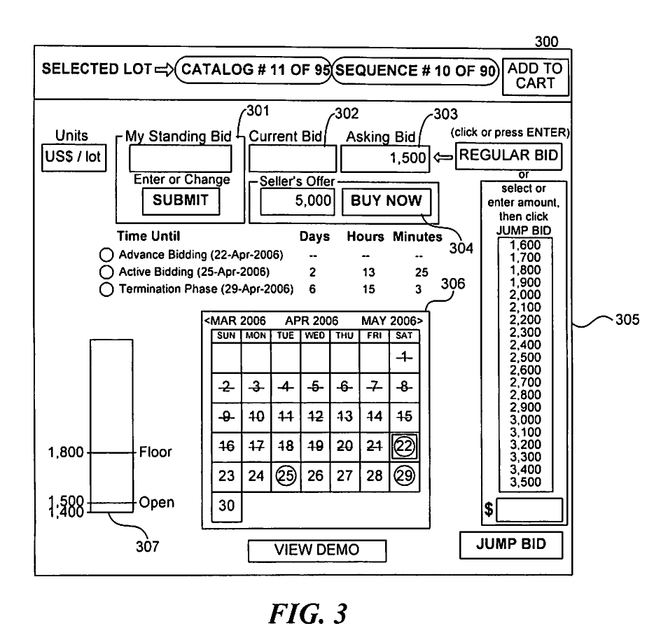

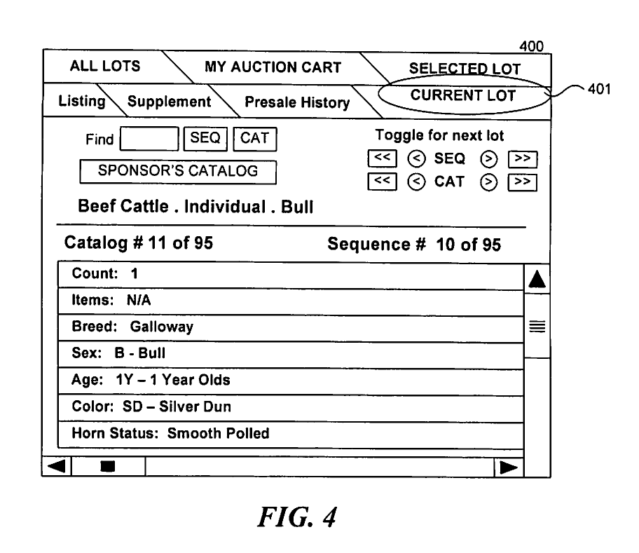

FIG. 3 is an example display page that illustrates a user interface displayed to a bidder in one embodiment. Display page 300 includes a standing bid area 301, a current bid area 302, an asking bid area 303, a buy now area 304, a jump bid area 305, a calendar area 306, and a bar chart graphic area 307. The standing bid area allows a user to input or change a standing bid. The current bid area displays the current highest bid while the auction is active. The asking bid area lists the current asking bid at the auction. When a user selects the regular bid button of the asking bid area, a bid is placed on behalf of the user for the asking bid. The jump bid area allows the user to enter a bid other than the current asking bid. A user may click on one of the numbers listed in the jump bid area or may manually enter a dollar amount and select the jump bid button. The calendar area displays a calendar with the dates of various phases of the auction and dates of other auction events. In this example, the advance bidding phase begins on April 22, the active bidding phase begins on April 25, and the termination phase occurs on April 29. The bar chart graphic area displays a bar chart that illustrates graphically how bidding has progressed during the active bidding phase. The open indicator indicates the minimum amount of the opening bid, and the floor indicator indicates the minimum amount that the seller is willing to accept to sell the lot. As the bidding progresses the auction system fills in the bar chart to indicate the increasing current bid. FIG. 4 is an example display page that illustrates detailed information about the current lot that is being auctioned. Display page 400 is displayed when the user selects to view additional information about the lot that is currently being auctioned. The user can select one of the sub-tabs to view even more detailed information about the lot.

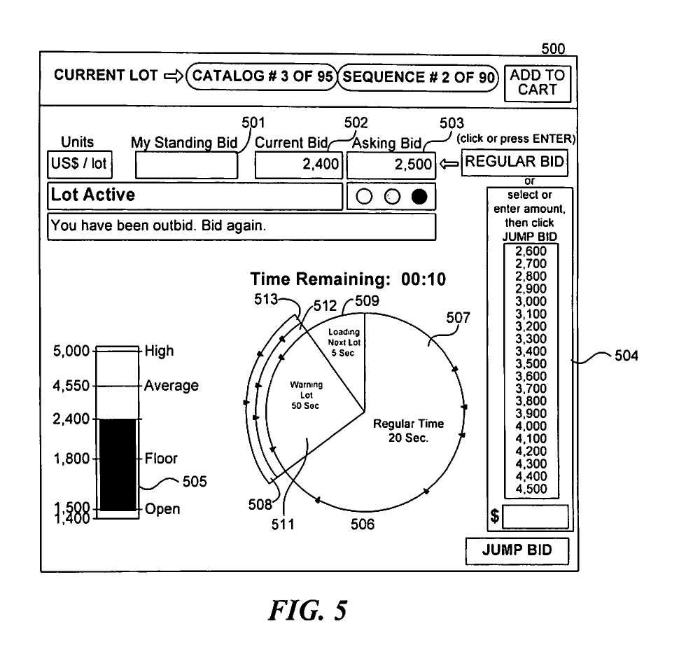

FIG. 5 is an example display page of a user interface displayed during the active bidding phase. Display page 500 includes a standing bid area 501, a current bid area 502, an asking bid area 503, a jump bid area 504, a bar chart graphic area 505, and a pie chart graphic area 506. The standing bid area, the current bid area, the asking bid area, and the jump bid area work as described above with reference to FIG. 3. The bar chart graphic area contains an average indicator that indicates the average price for similar lots and a high indicator that indicates the highest price paid for similar lots. The pie chart graphic area contains a regular time area 507, a fair warning area 508, and a time to next lot area 509. The areas of the pie chart represent time and are filled in by the auction system as time of the auctioning of the current lot elapses. In addition, the auction system displays an arrow at the perimeter of the pie chart to indicate the timing of each received bid. The fair warning area represents the safe harbor period as described above. Each time the auction is extended into overtime, the perimeter of the fair warning area is increased. A safe harbor area 511 indicates the safe harbor period. Extended circumference areas 512 and 513 indicate a first overtime and a second overtime. As indicated by the arrows in the safe harbor area and each extended circumference area, multiple bidders placed bids during those periods.

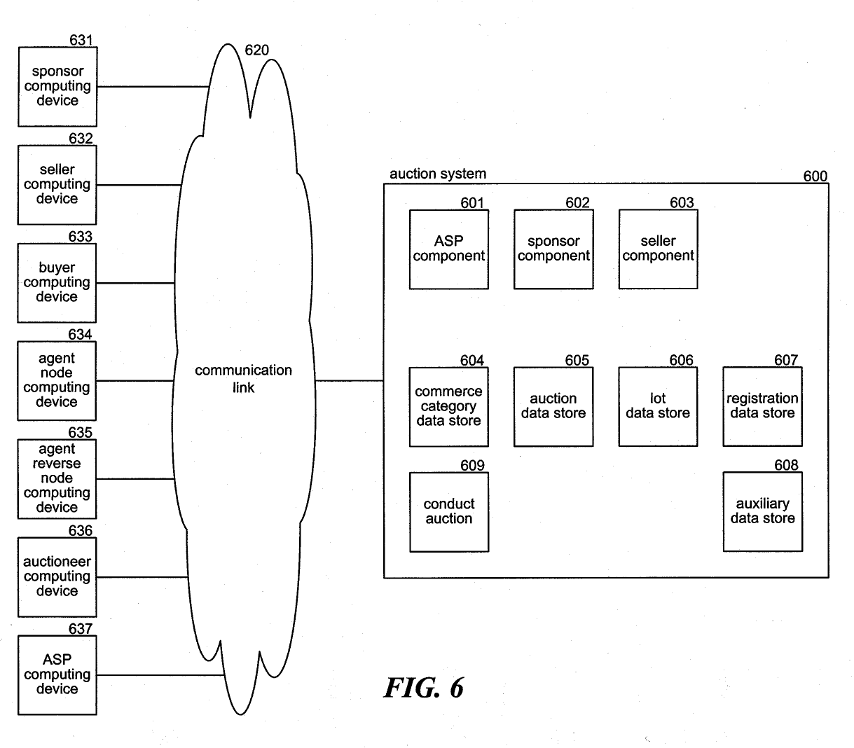

FIG. 6 is a block diagram that illustrates components of the auction system in one embodiment. The auction system 600 is connected to various computing devices 631-637 via communications link 620. The computing devices include a sponsor computing device 631, a seller computing device 632, a buyer computing device 633, an agent node computing device 634, an agent reverse node computing device 635, an auctioneer computing device 636, and an ASP computing device 637. Each computing device supports the functions needed by the sponsor, seller, buyer, and so on. The auction system 600 includes an ASP component 601, a sponsor component 602, a seller component 603, a commerce category data store 604, an auction data store 605, a lot data store 606, a registration data store 607, an auxiliary data store 608, a conduct auction component 609, and various phase components (not shown). The ASP component allows an application service provider to define commerce categories and requirements of various auctions that can be set up by the auction system. The sponsor component allows an auction sponsor to define an auction within various commercial categories and to specify the requirements of that auction. The seller component allows a seller to upload descriptions of lots to be sold at an auction set up by the sponsor. The auction system may also include a buyer component that operates in a way similar to the seller component in the case of a reverse auction. The commerce category data store includes a hierarchical representation of the commerce categories defined by the application service provider. The commerce category data store may also store information specifying how auctions in the various commerce categories are to be conducted and presented to users. The auction store contains an entry for each auction that has been set up by a sponsor and identifies the requirements and other attributes of the auction as specified by the sponsor. The lot store contains a description of the lots that have been specified by various sellers. The lot store may contain a description of the items along with the listing information and supplemental information along with information on how the auction is to be conducted (e.g., pre-emptive bidding allowed). The registration data store may contain an entry for each sponsor, seller, and buyer who is registered to use the auction system. The auction system may require users to register before bidding at each auction. The auxiliary data store contains additional information on the various lots such as video of the animals to be auctioned. The conduct auction component controls the overall conducting of an auction such as accepting bids at an online auction or signaling bids of network bidders at an external auction.

The computing device on which the auction system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the auction system. In addition, the data structures and message structures may be stored or transmitted via a data transmission medium, such as a signal on a communications link. Various communications links may be used, such as the Internet, a local area network, a wide area network, or a point-to-point dial-up connection.

The auction system may be implemented in various operating environments. Various well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The auction system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

The following flow diagrams illustrate the high-level functional processing of various components of the auction system.

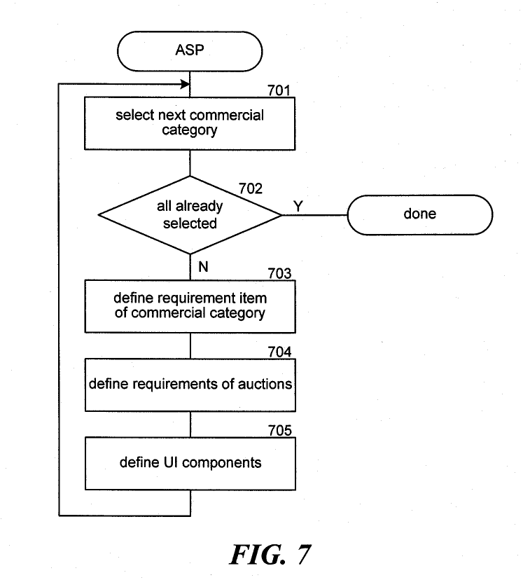

FIG. 7 is a flow diagram that illustrates the processing of the ASP component of the auction system in one embodiment. The component allows an application service provider to define commercial categories of auctions that the auction system will support along with the requirements of those auctions. In block 701, the component selects the next commercial category defined by the application service provider. In decision block 702, if all the commercial categories have already been selected, then the component completes, else the component continues at block 703. In block 703, the component receives from the ASP the requirements of the items in the selected commercial category. In block 704, the component receives from the ASP the requirements of the auctions for the selected commercial category. In block 705, the component receives from the ASP an indication of the user interface components to make available to the auction sponsors for the selected commercial category. For example, the ASP may indicate that an auction sponsor can specify a user interface feature for displaying a video relating to an item to be auctioned. The component then loops to block 701 to select the next commercial category.

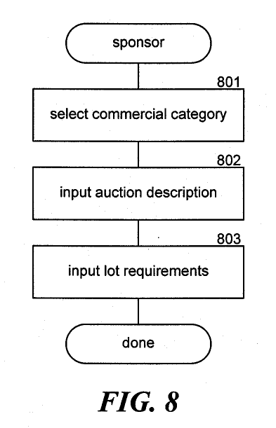

FIG. 8 is a flow diagram that illustrates the processing of the sponsor component of the auction system in one embodiment. The sponsor component allows a sponsor to set up an auction whose attributes comply with the requirements of the ASP. For example, an ASP may not allow reverse auctions. In block 801, the component receives from the sponsor a selection of a commercial category. In block 802, the component inputs a description of the auction including its attributes. The component ensures that the auction description is consistent with the requirements of the ASP. In block 803, the component inputs the requirements of the lots of the auction. The auction system ensures that lots uploaded by sellers comply with these requirements. For example, a requirement of a lot may be that a lot contain no more than 10 items. The component then completes.

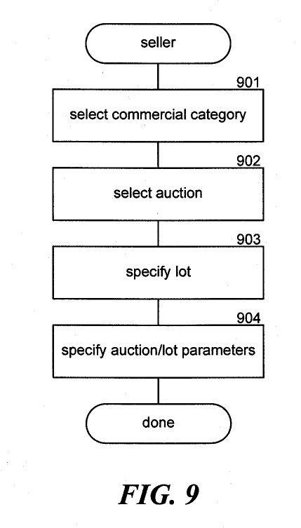

FIG. 9 is a flow diagram that illustrates the processing of the seller component of the auction system in one embodiment. The component allows a seller to upload a lot for an auction. In block 901, the component allows the seller to select a commercial category. For example, a user may select a commercial category of processed cattle. In block 902, the component allows the user to select an auction within the selected commercial category. In block 903, the component inputs from the seller the specification of a lot for the selected auction. In block 904, the component inputs from the user the specification of the attributes for auctioning the lot. For example, one attribute may be a pre-emptive bid amount or a minimum bid amount. The component then completes.

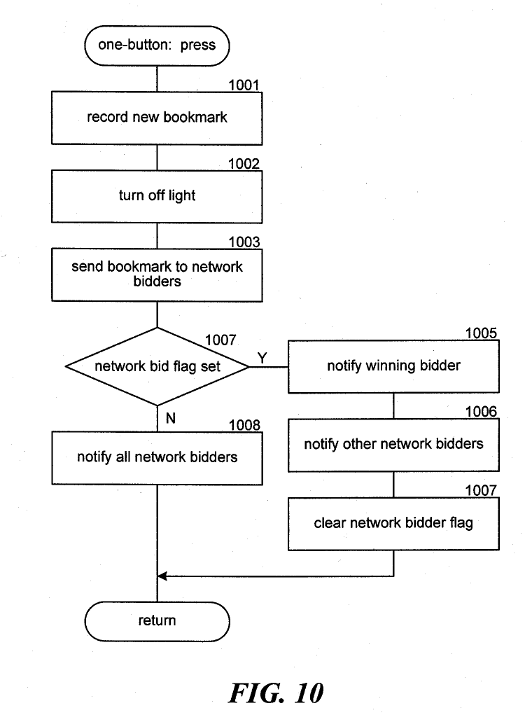

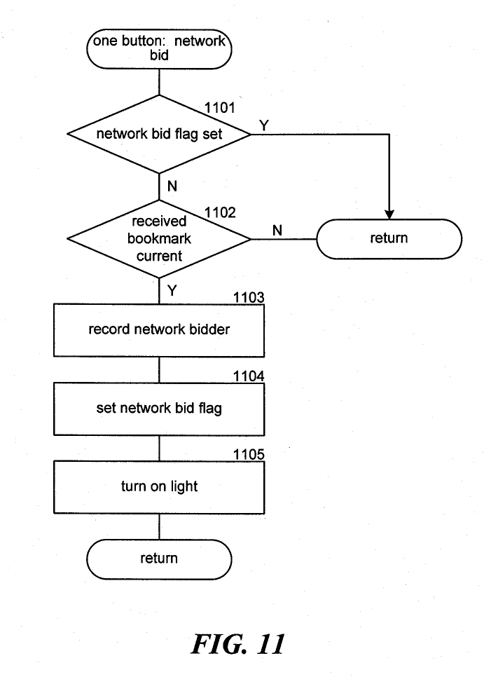

FIGS. 10 and 11 illustrate the operation of an external auction with network bidders in a one-button environment. FIG. 10 is a flow chart that illustrates the processing of a one-button press component of the auction system in one embodiment. The component is invoked during an external auction whenever the auctioneer presses the button. In block 1001, the component records a new bookmark with a time stamp. In block 1002, the component turns off the light of the button. In block 1003, the component sends the new bookmark to each network bidder. In decision block 1004, if the network bid flag is set indicating that a bid was received from a network bidder, then the component continues at block 1005, else the component continues at block 1008. In block 1005, the component notifies the winning network bidder with the appropriate winning bid sound. In block 1006, the component notifies the other network bidders with the appropriate new asking bid sound. In block 1007, the component clears a network bidder flag and then returns. In block 1008, the component notifies all the network bidders with the new asking bid sound and then returns.

FIG. 11 is a flow diagram that illustrates the processing of a one-button network bid component of the auction system in one embodiment. The component is invoked when a network bid is received. In decision block 1101, if the network bid flag is set, then the auction system has already received a network bid at the current asking bid and the component discards the bid and returns, else the component continues at block 1102. In decision block 1102, if the received bookmark matches the current bookmark, then the received bid is for the current asking bid and the component continues at block 1103, else the component discards the bid and returns. In block 1103, the component records the network bidder's identity. In block 1104, the component sets a network bid flag to indicate that a bid from a network bidder has been accepted. In block 1105, the component turns on the light on the button and then returns.

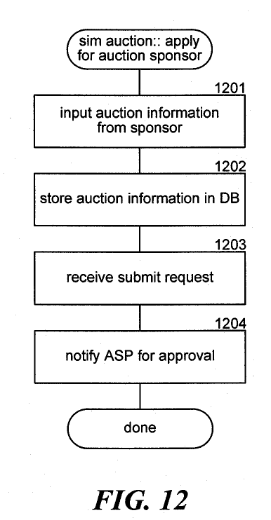

FIGS. 12-17 illustrate more detailed processing of the sponsoring of an auction. FIG. 12 is a flow diagram that illustrates the processing of an apply for auction sponsor component of the auction system in one embodiment. The component is invoked when a user wants to sponsor an auction. In block 1201, the component inputs auction information from the sponsor. In block 1202, the component stores the auction information in the auction database (the data stores of FIG. 6). In block 1203, the component receives a request from the sponsor to submit the sponsorship for approval. In block 1204, the component notifies the ASP that a sponsor has requested approval of an auction. The notification may be sent via electronic mail to the ASP. The component then returns.

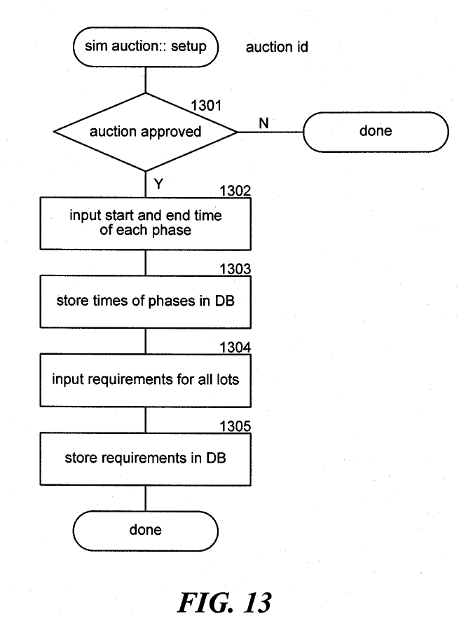

FIG. 13 is a flow diagram that illustrates the processing of a set up auction component of the auction system in one embodiment. The component is invoked when a sponsor wants to set up an auction. The component ensures that the auction has been approved by the ASP and inputs the requirements and attributes of the auction. In decision block 1301, if the auction is approved, then the component continues at block 1302, else the component completes. In block 1302, the component inputs the start and end time of each phase of the auction. In block 1303, the component stores those times in the auction database. In block 1304, the component inputs the requirements of all the lots of the auction and then continues at block 1305. In block 1305, the component stores the requirements in the auction database and then completes.

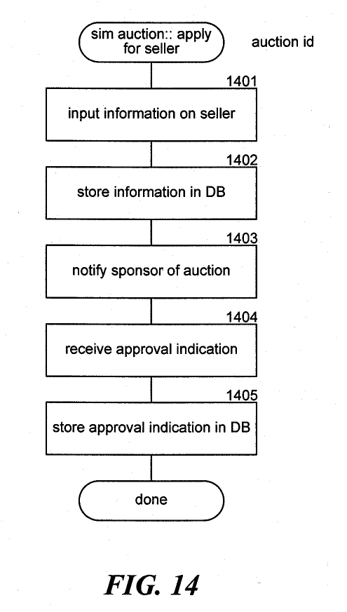

FIG. 14 is a flow diagram illustrating the processing of an apply for seller component of the auction system in one embodiment. The component is invoked when a seller wants to apply for approval to upload lots to an auction. In block 1401, the component inputs information on the seller. In block 1402, the component stores the information in the auction database. In block 1403, the component notifies the sponsor of the request to add lots to the auction. In block 1404, the component receives an approval from the sponsor. In block 1405, the component stores the approval indication in the auction database and then completes.

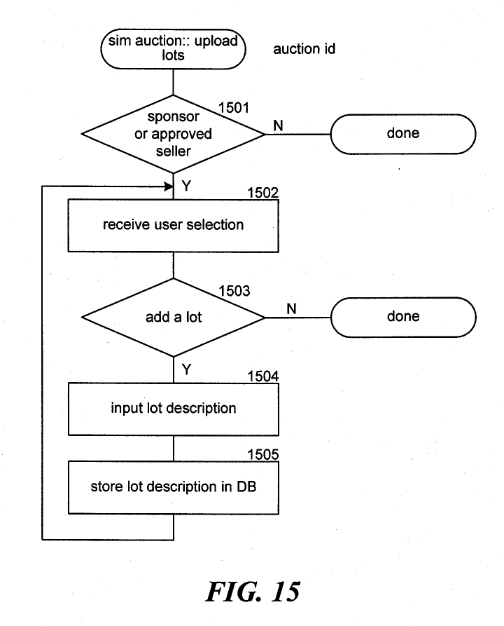

FIG. 15 is a flow diagram that illustrates the processing of the upload lots component of the auction system in one embodiment. The component is invoked when a sponsor or an approved seller wants to upload a lot to an auction. In decision block 1501, if the user is the auction sponsor or an approved seller, then the component continues at block 1502, else the component completes. In blocks 1502-1505, the component loops inputting a selection of whether the user wants to continue adding lots to the auction. In block 1502, the component receives the selection from the user. In decision block 1503, if the user wants to continue adding lots, then the component continues at block 1504, else the component completes. In block 1504, the component inputs a description of the lot. In block 1505, the component stores the description of the lot in the auction database and then loops to block 1502 to select the next user selection.

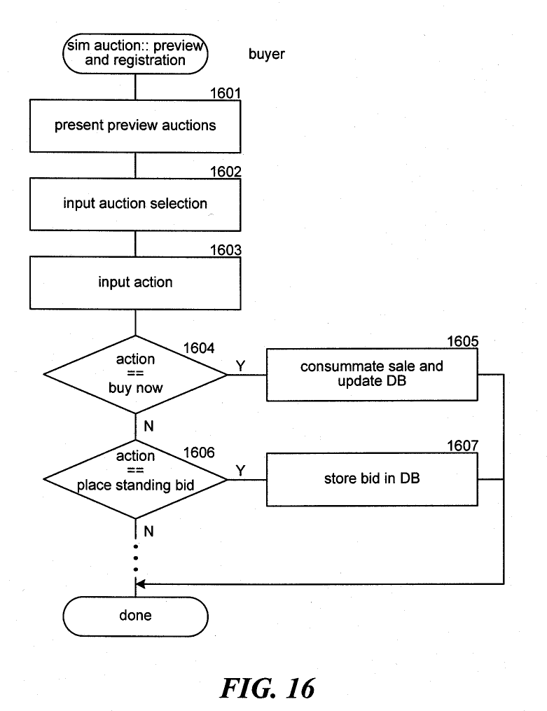

FIG. 16 is a flow diagram that illustrates the processing of a preview and registration component of the auction system in one embodiment. The component allows a potential buyer to preview auctions and register for the auctions. In block 1601, the component presents a preview of auctions to a buyer. In block 1602, the component inputs a selection of an auction from the buyer. In block 1603, the component inputs an action that the buyer wants to take relative to the selected auction. In decision block 1604, if the action is a buy now or pre-emptive bid action, then the component continues at block 1605, else the component continues at block 1606. In block 1605, the component consummates the sale of a selected lot and updates the auction database and then completes. In decision block 1606, if the action is to place a standing bid, then the component continues at block 1607, else the component continues with any other possible actions. In block 1607, the component stores the standing bid in the auction database and then completes.

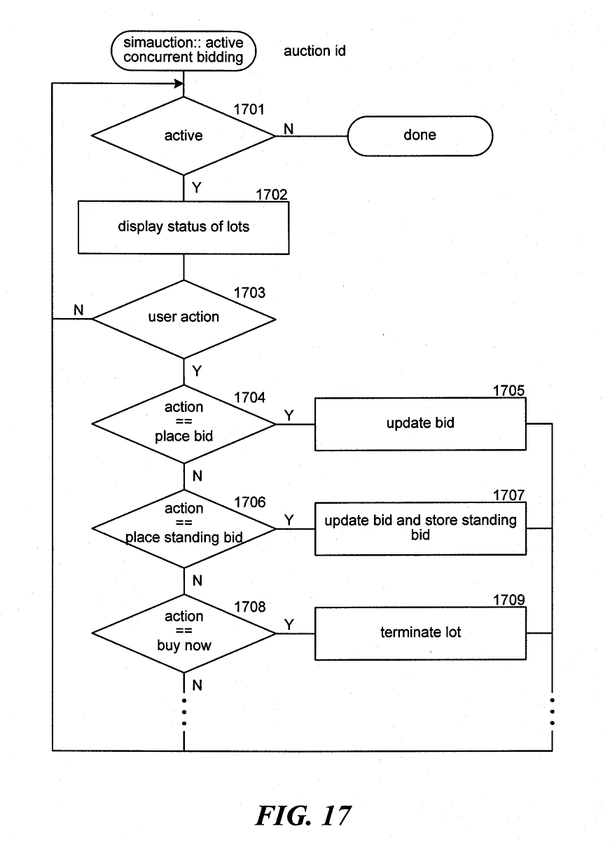

FIG. 17 is a flow diagram that illustrates the processing of an active bidding component of the auction system in one embodiment. The component is passed an auction identifier and conducts an auction for a lot of that auction. In decision block 1701, if the auction is active, then the component continues at block 1702, else the component completes. In block 1702, the component displays the status of the lots to a user. In block 1703, if a user action is input, then the component continues at block 1704, else the component continues loops to block 1701. In decision block 1704, if the user action is to place a bid, then the component continues at block 1705, else the component continues at block 1706. In block 1705, the component updates the asking bid and establishes a new current bid and then loops to block 1701. In decision block 1706, if the user action is to place a standing bid, then the component continues at block 1707, else the component continues at block 1708. In block 1707, the component updates the current bid and stores the standing bid for the user and then loops to block 1701. In decision block 1708, if the user action is to buy now, then the component continues at block 1709, else the component continues processing any possible further actions by the user. In block 1709, the component terminates the lot and consummates the sale with the user and then loops to block 1701.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A method in a computer system for conducting an elastic auction, the method comprising:
creating an auction specifying a quantity of items to be auctioned as a fractionated lot;
while the auction is open,
receiving bids from bidders, each bid specifying a fraction of the quantity of items of the fractionated lot and a bid amount;
receiving modifications to bids that can withdraw the bid, increase or decrease the fraction of the bid, and raise or lower the bid amount of a bid; and
presenting each bid to each bidder; and
when the auction closes, designating as winning bids those bids pending at the time closing whose fractions total not more than the quantity of items in the fractionated lot.

2. The method of claim 1 wherein the elastic auction is a direct auction and the winning bids have the highest bid amounts.

3. The method of claim 2 wherein the items of the fractionated lot are not identical and the bidders of the winning bids choose items of the fractionated lot in bid amount order.

4. The method of claim 1 wherein the elastic auction is a reverse auction and the winning bids have the lowest bid amounts.

5. The method of claim 1 wherein a bidder can have multiple bids pending at the elastic auction at the same time.

6. The method of claim 1 wherein the elastic auction can have multiple lots.

7. The method of claim 6 wherein the bidding on the multiple lots can be specified to close simultaneously.

8. The method of claim 6 wherein the bidding on the multiple lots can be specified to close sequentially.

9. A method in an auction system of conducting an auction, the method comprising:
receiving a specification of items to be auctioned in multiple lots;
receiving from bidders bids that specify a lot of the items and a bid for a fraction of the items;
allowing bidders to modify their pending bids by raising, lowering, or withdrawing their bids;
allowing bidders to view the pending bids of other bidders; and
upon termination of the auction,
for each lot,
identifying pending bids for up to a certain quantity of items as winning bids; and
establishing a contract for each winning bid at a contract price that is derived from the prices of the winning bids.

10. The method of claim 9 wherein the items are to be sold by the bidders.

11. The method of claim 9 wherein the items are to be purchased by the bidders.

12. A computing device for controlling an elastic auction, comprising:
a component that creates an auction that specifies a lot with a quantity of items to be auctioned by a sponsor;
a component that receives from bidders bid submissions, bid withrawals, and bid modications, such that a bid submission specifies a bid amount, a bid withdrawal specifies to withdraw a previously submitted bid, and a bid modification specifies to raise or lower the bid amount of a previously submitted bid; and
a component that, upon termination of the auction, identifies the submitted bid with the highest that was not withdrawn as the winning bid.

13. The computing device of claim 12 wherein the lot is a fractionated lot and a bid submission specifies a fraction of the fractionated lot.

14. The computing device of claim 13 wherein multiple bids are identified as being winning bids whose combined fractions do not exceed the quantity of the lot.

15. The computing device of claim 14 wherein the winning bidders select items of the fractionated lot in order of their bid amounts.

16. The computing device of claim 12 wherein the auction is a reverse auction in which the bidders sell the items to the sponsor.

17. The computing device of claim 12 wherein the auction is a direct auction in which bidders buy the items from the sponsor.
